(19) United States
(12) Patent Application Publication
(10) Pub. No.: US 2015/0382237 A1
(43) Pub. Date: Dec. 31, 2015

(54) NETWORK APPARATUS BASED ON ORTHOGONAL FREQUENCY-DIVISION MULTIPLEXING (OFDM) AND DATA COMPRESSION AND DATA RECOVERY METHOD THEREOF USING COMPRESSED SENSING

(71) Applicant: ELECTRONICS AND TELECOMMUNICATIONS RESEARCH INSTITUTE, Daejeon-si (KR)

(72) Inventors: Seung Hwan KIM, Daejeon-si (KR); Seung Hyun CHO, Daejeon-si (KR); Sang Soo LEE, Daejeon-si (KR)

(21) Appl. No.: 14/733,095

(22) Filed: Jun. 8, 2015

(30) Foreign Application Priority Data
Jun. 27, 2014 (KR) 10-2014-0080012

(51) Int. Cl. H04W 28/06; H04L 27/26; H04J 11/00

(52) U.S. Cl. CPC H04W 28/06; H04J 11/00; H04L 27/2627; H04L 27/2642; H04L 27/2636; H04J 2011/0009

(57) ABSTRACT

A network apparatus as well as a data compression and data recovery method thereof using compressed sensing (CS). According to an exemplary embodiment, the data compression and recovery method may include compressing raw digital signals by using CS; modulating and transmitting the compressed raw digital signals; receiving and demodulating the modulated raw digital signals; and recovering the raw digital signals by decompressing, by using CS, the demodulated raw digital signals.

### CROSS-REFERENCE TO RELATED APPLICATION(S)

This application claims the benefit under 35 U.S.C. §119(a) of Korean Patent Application No. 10-2014-0080012, filed on Jun. 27, 2014, in the Korean Intellectual Property Office, the entire disclosure of which is incorporated herein by reference for all purposes.

### BACKGROUND

1. Field

The following description relates to network technology based on orthogonal frequency-division multiplexing (OFDM), and more particularly, a technology for reducing the bandwidth of an interface signal that is transmitted through a digital interface.

2. Description of the Related Art

Orthogonal frequency-division multiplexing (OFDM) method is widely used for wired/wireless communications due to the ease in which data may be transmitted at high speeds and bandwidth expandability. OFDM technology can be applied to a passive optical network (PON).

A sharp increase in traffic demands is expected between network transmitting nodes in network infrastructure such as distributed cloud-RAN (C-RAN). Thus, a technology is required which can reduce up to the several times or ten times compared to the present bandwidth of an interface signal that handles large-scale traffic between the transmitting devices. For example, in a case in which a wireless base station uses a serial interface e.g., a common public radio interface (hereinafter referred to as CPRI), a transmission bandwidth of an interface signal needs to be drastically reduced in consideration of expansion of wireless base stations for telecom service providers or device manufacturers.

### SUMMARY

Provided is an apparatus and method for increasing usage efficiency of transmission bandwidth through compression and recovery of interface signals, which are transmitted between network devices over a wired/wireless network based on orthogonal frequency-division multiplexing (OFDM).

In one general aspect, an OFDM-based network apparatus includes compressors to compress raw digital signals by using compressed sensing (CS), and a modulator to modulate the raw digital signals that have been compressed by the compressors.

In another general aspect, an OFDM-based network apparatus includes a demodulator to receive a modulated compressed signal that was once a raw digital signal, and to demodulate the modulated compressed signal, and recoverers to recover the compressed signal to the raw digital signal by decompressing the compressed signal, which has been demodulated through the demodulator, by using compressed sensing (CS).

In another general aspect, the data compression and recovery method of an OFDM-based network apparatus includes compressing raw digital signals by using compressed sensing (CS); modulating and transmitting the compressed raw digital signals; receiving and demodulating the modulated raw digital signals; and recovering the raw digital signals by decompressing, by using CS, the demodulated raw digital signals.

Other features and aspects may be apparent from the following detailed description, the drawings, and the claims.

### BRIEF DESCRIPTION OF THE DRAWINGS

FIG. 1 is a diagram illustrating a network system based on orthogonal frequency-division multiplexing (OFDM) according to an exemplary embodiment.

FIG. 2 is a reference diagram illustrating usage efficiency of a transmission bandwidth.

FIG. 3 is a detailed diagram illustrating an example of a transmitting network device.

FIG. 4 is a detailed diagram illustrating an example of a receiving network device according to FIG. 1.

FIG. 5 is a flowchart illustrating an example of a data compression and recovery method using compressed sensing.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

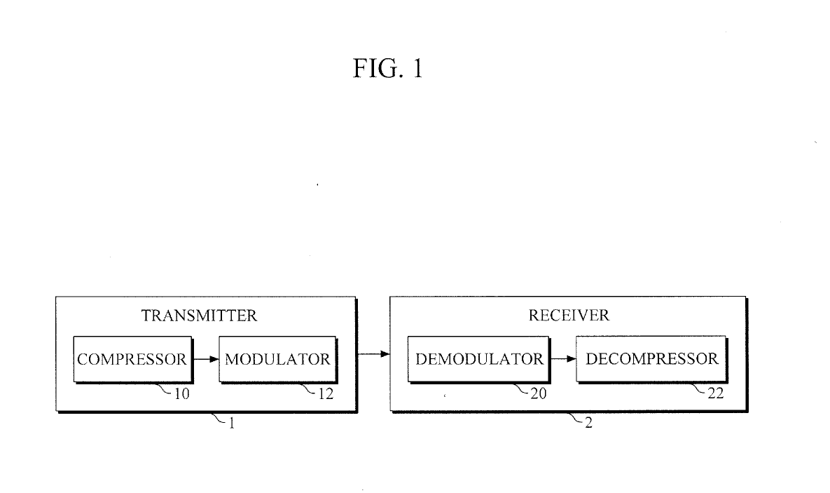

FIG. 1 is a diagram illustrating a network system based on orthogonal frequency-division multiplexing (OFDM) according to an exemplary embodiment.

Referring to FIG. 1, an OFDM-based network system includes a transmitter 1 and a receiver 2, which is connected to the transmitter 1 through a network transmission medium and transmits and receives OFDM signals.

The transmitter 1 and the receiver 2 may be base stations, exchange stations, or personal terminals. For example, the relationship between the transmitter 1 and the receiver 2 may be that of base station-base station, exchange station-personal terminal, or base station-personal terminal, each of which is connected through a network transmission medium. The transmitter 1 and the receiver 2 are distributed wireless base stations, which are located in a passive optical network (OFDM-PON) based on orthogonal frequency-division multiplexing; hence, as examples, transmitter 1 is a digital unit (DU), and the receiver 2 is a radio unit (RU).

The network transmission medium that connects the transmitter 1 and the receiver 2 may be a digital interface that transmits and receives a serial signal of a digital type. As demands for network infrastructure such as distributed cloud-RANs sharply increase, the bandwidth of an interface signal handling large-scale traffic between network devices needs to be reduced. The present disclosure aims to maximally reduce the bandwidth of an interface signal transmitted through the digital interface by applying compressed sensing (CS) technology and OFDM at the same time.

Referring to FIG. 1, the transmitter 1 includes compressors 10 and a modulator 12. The compressors 10 compress raw digital signals by using compressed sensing (CS). A raw digital signal is a signal that has yet to be the compressed, or in other words, all signals that are in binary code which are used in a wired or wireless network system. For example, if an input signal in a mobile communication system is a long-term evolution (LTE) signal, said input signal would be an in-phase and quadrature (IQ) data baseband signal that may be expressed in binary code that is more or less than 15 bits. In another example, if an input signal is an OFDM signal, the raw digital signal may be expressed as 6 bits of data when using 64-quadrature amplitude modulation (QAM). In addition, the raw digital signal may use entire transmission frames defined in various transmission fields or only use a specific field value within the transmission frame.

A signal to be compressed by a compressor 10, is a ‘sparse signal’, which when converted to a specific domain, is a signal whose elements are not all zeros, but rather a signal whose elements sparsely show non-zero values. When illustrated on a graph, a sparse signal has a zero value at several coordinates and a very small number of non-zero values at others. The sparsity indicates that there is the very small number of non-zero values at a sparse signal. Thus, the signal that has a non-zero value may be much shorter than the length of data that a user wanted to originally transmit, and in such a case, the sparse signal may be successfully compressed through CS. Furthermore, a sparse signal that has been compressed into a compressed signal may be successfully recovered with a high probability by using a specific algorithm.

If a signal vector has numerous zeros, CS may recover the raw signal using a higher compression ratio than that of Nyquist sampling. Generally, Nyquist sampling is capable of recovering the raw signal only when sampling a signal at a rate higher than the Nyquist rate. However, through CS, the raw signal may be recovered completely even when sampling a signal at a rate lower than the Nyquist rate. Here, the measurement number of signals required for signal processing may be reduced using the sparsity of the sparse signal.

The modulator 12 modulates signals that have been compressed by the compressors 10. The modulator 12 modulates general OFDM signal, and the modulated compressed signals are transmitted to the receiver 2 through a digital interface.

The receiver 2 includes a demodulator 20 and recoverers 22. The demodulator 20 can demodulate an OFDM signal that has been received through a digital interface. The recoverers 22 recover OFDM data that is in a compressed state, and produces the characteristics of the raw digital signals. The recovery of the signal may be to a level wherein the characteristics of the raw signal have been restored; if at this time, this restored signal has an error vector magnitude (EVM) that is below the error threshold, then said signal may be construed a recovered signal; furthermore, if at this time, the loss between the compression and recovery processes of a signal is less than 3%, the recovered signal may be construed the same as the raw signal.

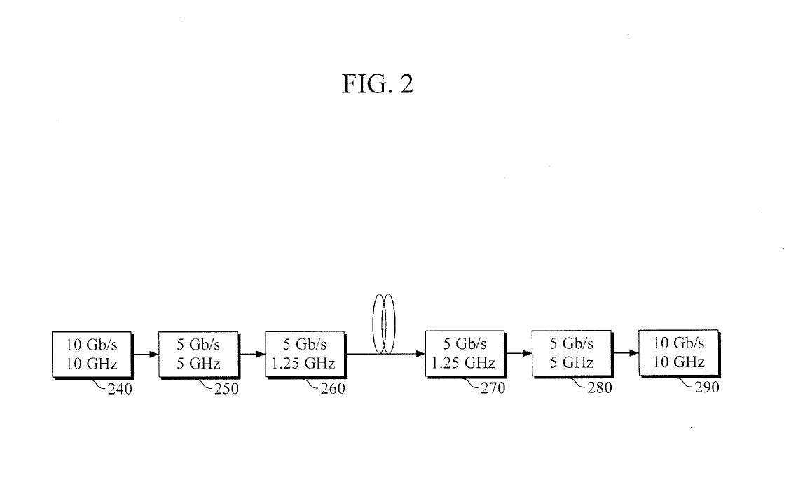

FIG. 2 is a reference diagram illustrating usage efficiency of a transmission bandwidth.

Referring to FIGS. 1 and 2, an uncompressed raw digital signal 240, which is an input signal of a transmitter 1, is compressed by a compressor 10 using compressed sensing (CS). Then, the compressed signal, as depicted in 250, is modulated by a modulator 12, and the modulated compressed signal, as depicted in 260, is transmitted to a receiver 2 through a digital interface e.g., a single-mode optical fiber (SMF). The required transmission bandwidth of the uncompressed raw digital data 240 is 10 GHz; the required transmission bandwidth of the compressed signal 250, 5 GHz; and the required transmission bandwidth of the modulated compressed signal 260, 1.25 GHz. If the uncompressed raw digital data, depicted in 240, is compressed as depicted in 250, its required transmission bandwidth is reduced to half, and the required transmission bandwidth of the compressed signal in 260, which was modulated from the compressed signal in 250, is reduced again to one quarter. Thus, the bandwidth is reduced to a total of one eighth of its original capacity if both the compression and the modulation are applied at the same time. In such a case, an amount of data that is transmitted between the transmitter 1 and the receiver 2 may be dramatically reduced.

Based on standardization and requests of industries, etc., the short-term prediction is that interface bandwidth sizes of network devices will be reduced by more than half, while the long-term, theoretical prediction proposes that bandwidth sizes may be reduced to an eighth of the original size when OFDM-based multiplexing is doubled. The present invention is capable of reducing the bandwidth size of an interface signal that is transmitted by a digital interface, by applying both CS technology and OFDM-based multiplexing at the same time, to an eighth of its original size.

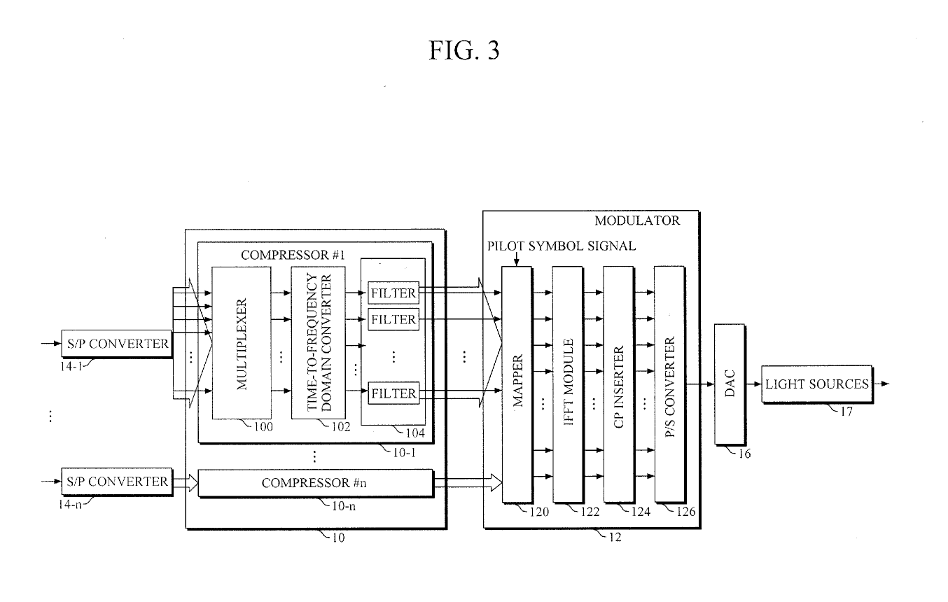

FIG. 3 is a detailed diagram illustrating an example of a transmitting network device.

Referring to FIGS. 1 and 3, a transmitter 1 includes serial-to-parallel converters 14-1, . . . , 14-n (hereinafter referred to as S/P converters), compressors 10, a modulator 12, a digital-to-analog converter 16 (hereinafter referred to as a DAC), and light sources 17.

The compressors 10 may refer to multiple compressors 10-1, . . . , 10-n. These compressors are divided into compression blocks 10-1, . . . , 10-n according to the modulation method (e.g., a quadrature amplitude modulation (QAM) method) of the modulator 12, and compresses the raw digital signal by way of compressing each of its divided compression blocks.

First, the S/P converters 14-1, . . . , 14-n convert serial data, which is based on the serial interface, such as a common public radio interface (CPRI), into parallel data, and transmit the parallel data to the compressors 10. The parallel data consist of several bits e.g., two to seven bits. Each of the compressors 10-1, . . . , 10-n may include a multiplexer (MUX) 100, a time-to-frequency domain converter 102, and further include filters 104.

To apply compressed sensing to the parallel data that has been converted at each of the S/P converters 14-1, . . . , 14-n, the MUX 100 multiplexes two or more channel signals to one (for example, 2×1, 3×1, and 4×1) and outputs the combined signal to the time-to-frequency domain transformer 102. The time-to-frequency domain converter 102 converts the signal, which has been received from the MUX 100, from a time domain to a frequency domain, and compresses the converted signal. Such is a basic and essential technology for compressed sensing, which is performed to increase sparsity in converting to a frequency domain. The sparsity indicates a data share that shows zero or a value close to zero out of the entire data. For example, the time-to-frequency domain converter 102 may convert the domain using a fast Fourier transform (FFT), a discrete cosine transform (DCT), and a discrete wavelet transform (DWT), etc., and compress a signal by using such.

The filters 104 may be low pass filters (LPF). The filters 104 receive signals that have been output from the time-to-frequency domain converter 102, samples the data at a value that is set according to standardization of a communications protocol service, and removes unnecessary data components but only to a degree that does not go beyond the error threshold.

The modulator 12 receives the signal compressed by each of the compressors 10-1, . . . , 10-n and performs a general OFDM model modulation function. The modulator 12 includes a mapper 120, an inverse fast Fourier transform (FFT) module 122 (hereinafter referred to as IFFT module), a cyclic prefix (CP) inserter 124, and a parallel-to-serial converter 126 (hereinafter referred to as P/S converter).

The mapper 120 receives the signals compressed by the compressors 10-1, . . . , 10-n, maps the compressed signals into symbols, inserts a pilot symbol signal into each of the mapped signals, and provides the result to the IFFT module 122. The IFFT module 122 modulates, including IFFT, the symbols that have been received from the mapper 120, converts signals to a time domain, and outputs them. The output signals are carried on each different carrier, which is orthogonal to each other. The CP inserter 124 inserts cyclic prefixes to the signals so as to prevent interference between channels. The P/S converter 126 converts a low-speed parallel signal into a high-speed serial signal and transmits the converted signal to the DAC 16. The DAC 16 converts a signal of the serially-converted digital data type into an analog signal. The light sources 17 optically transmit the converted analog signal which is carried therein.

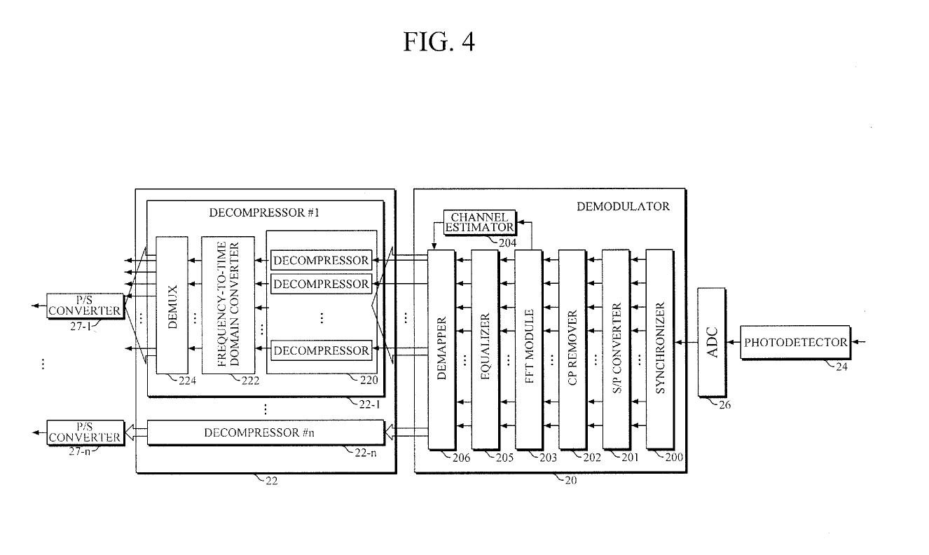

FIG. 4 is a detailed diagram illustrating an example of a receiving network device according to FIG. 1.

Referring to FIG. 4, a receiver 2 includes a photodiode 24, an analog-to-digital converter 26 (hereinafter referred to as ADC), a demodulator 20, recoverers 22, and P/S converters 27-1, . . . , 27-n.

The photodiode 24 detects an analog signal that has been transmitted optically, and the ADC 26 converts the detected analog signal into a digital signal and then outputs the digital signal to the demodulator 20.

The demodulator 20 includes a synchronizer 200, an S/P converter 201, a CP remover 202, a fast Fourier transform (FFT) module 203, a channel estimator 204, an equalizer (EQ) 205, and a demapper 206.

The synchronizer 200 synchronizes the digital signal that has been converted in the ADC 26, and the S/P converter 201 converts the synchronized digital signal from its serial form into a parallel form. The CP remover 202 removes the cyclic prefix that was inserted into the parallel signal converted in the S/P converter 201. The FFT module 203 performs an FFT on the signal from which the cyclic prefix has been removed and then converts said signal from a time domain to a frequency domain. The EQ 205 equalizes the channel for the signal coming from the FFT module 203. Here, the EQ 205 performs the equalization required for digital signal decompression that is to be conducted by the recoverers 22. Since the EQ 205 is substituting the equalization function of the recoverers 22 at this time, block configuration may be simple. Then, the demapper 206 demaps the signal that has been output from the EQ 205 and transmits the demapped signal to a recoverer in 22. The channel estimator 204 may estimate a channel between the transmitter and the receiver according to the signal that has been converted by the FFT module 203 using a fast Fourier transform.

The recoverers 22 may refer to multiple recoverers 22-1, . . . , 22-n. These recoverers are divided into decompression blocks 22-1, . . . , 22-n according to a demodulation method (e.g., QAM method) of the demodulator 20 and recovers the compressed signals by way of decompressing each of its decompression blocks. Each of the recoverers 22, 22-1, . . . , 22-n includes decompressors 220, a frequency-to-time domain converter 222, and a demultiplexer (DEMUX) 224.

The decompressor 220 decompresses the compressed signal through a recovery method using L1 minimization that is used as CS technique. The L1 minimization is a method of recovering the original raw signal that has been compressed to be below the Nyquist rate, whereby the recovery process is repeated until the error value is below the error threshold so as to recover the desired data. Then, the frequency-to-time domain converter 222, corresponding to the time-to-frequency domain converter 102 of the compressors 10 in FIG. 3, converts the signal from a frequency domain to a time domain. Here, the frequency-to-time domain converter 222 may perform the Fourier inverse transform, an inverse cosine transform, or an inverse wavelet transform. The DEMUX 224 recovers the raw digital signal through demultiplexing. P/S converters 27-1, . . . , 27-n convert the recovered raw digital signals from a parallel form into serial form which said converters then output the result.

What has been described above is the background of the present invention along with examples of its application in in-phase/quadrature (I/Q) data that follows transmission protocols between distributed wireless base station devices. However, the application of the present invention is not limited to distributed wireless base stations but may be applied to other areas in the field of network communications (e.g., access networks or backbone networks). Alternatively, as a network transmission medium, the present invention may be applied to a wired/wireless system, the system using coaxial cables, or the combined system using both wired and wireless communications. Alternatively, the present invention may be applied to a network device as a multiplexing system in which time division, frequency division, wavelength division, code division, Orthogonal Frequency-Division Multiple Access (OFDMA), etc. are applied. As a network device, the present invention may be applied to a router, switch, and terminal, or to satellite communications, fixed wireless communications, and wireless mobile communications systems. Furthermore, the present invention may be widely applied to the hardware or software of various communications systems that need to be able to conduct compression and recovery to the data to be transmitted through the networks.

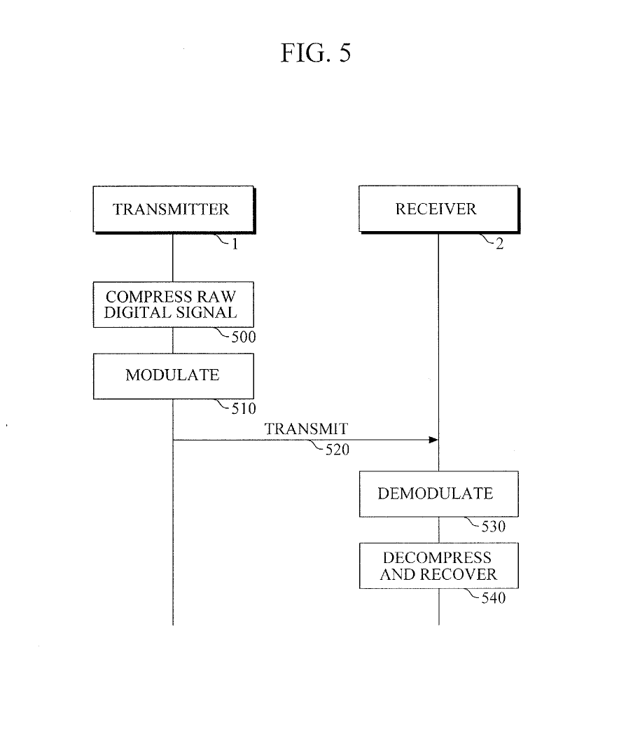

FIG. 5 is a flowchart illustrating an example of a data compression and recovery method using compressed sensing.

Referring to FIGS. 1 and 5, an OFDM-based network transmitter 1 compresses a raw digital signal using compressed sensing (CS), as depicted in 500, modulates the compressed signal to a receiver 2, as depicted in 510, and transmits the modulated signal to a receiver 2, as depicted in 520. Here, the transmitter 1 and the receiver 2 may be connected to each other through a digital interface. The receiver 2 demodulates and decompresses the signal received as depicted in 530, and decompresses the raw digital signal as depicted in 540. In such a case, the bandwidth of an interface signal transmitted through the digital interface may be maximally reduced by applying both CS technology and OFDM at the same time.

According to an exemplary embodiment, in a case of transmitting and receiving an OFDM signal using a digital interface, all types of capital expenditures (hereinafter referred to as CAPEX) and operating expenditure (hereinafter referred to as OPEX) may be dramatically reduced as a bandwidth of an interface signal transmitted through the digital interface is reduced. Particularly, in distributed base station markets, next generation mobile communications markets to be developed in the future, especially in cases where the digital interface is connected between an exchange station and a personal terminal, or a digital interface is connected between a base station and a personal terminal, the CAPEX and OPEX of communications service providers may be reduced dramatically. In such a case, it is predicted that a technology, which coexists communications enterprises, device manufacturing enterprises, content and service providing enterprises, consumers, etc., may be developed.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A network apparatus based on orthogonal frequency division multiplexing (OFDM), the network apparatus comprising:
compressors configured to compress raw digital signals by using compressed sensing (CS); and
a modulator configured to modulate the raw digital signals that have been compressed by the compressors, and to transmit the modulated raw digital signals.

2. The OFDM-based network apparatus of claim 1, wherein the compressors are configured to compress the raw digital signals so as to maximize their sparsity.

3. The OFDM-based network apparatus of claim 1, wherein the compressors are configured to compress the raw digital signals by sampling the raw digital signals at a rate below the Nyquist rate.

4. The OFDM-based network apparatus of claim 1, wherein the compressors are configured to be divided into compression blocks according to a modulation method of the modulator and to compress the raw digital signals by way of compressing each of the divided compression blocks.

5. The OFDM-based network apparatus of claim 1, wherein the compressors comprise:
a multiplexer (MUX) configured to multiplex a plurality of raw digital signals; and
a time-to-frequency domain converter configured to convert the plurality of multiplexed raw digital signals from a time domain to a frequency domain.

6. The OFDM-based network apparatus of claim 5, wherein the time-to-frequency domain converter is configured to perform a fast Fourier transform, a cosine transform, or a wavelet transform.

7. The OFDM-based network apparatus of claim 1, wherein the modulator is configured to transmit the modulated raw digital signals through the digital interface.

8. The OFDM-based network apparatus of claim 1, wherein the OFDM-based network apparatus is a distributed base station.

9. The OFDM-based network apparatus of claim 1, wherein the raw digital signals are baseband signals prior to compression.

10. An OFDM-based network apparatus, comprising:
a demodulator configured to receive a modulated compressed signal that was once a raw digital signal, and to demodulate the modulated compressed signal; and
recoverers configured to recover the compressed signal to the raw digital signal by decompressing the compressed signal, which has been demodulated through the demodulator, by using compressed sensing (CS).

11. The OFDM-based network apparatus of claim 10, wherein the recoverers are configured to, by using CS, recover the raw digital signals based on raw digital signals that have been sampled at a rate below the Nyquist rate and compressed.

12. The OFDM-based network apparatus of claim 10, wherein the recoverers are configured to be divided into decompression blocks according to a demodulation method of the demodulator and to recover the compressed signals by way of decompressing each of the divided decompression blocks.

13. The OFDM-based network apparatus of claim 10, wherein the recoverers comprise:
decompressors configured to decompress the demodulated compressed signals by using CS;
a frequency-to-time domain converter configured to convert the decompressed signals from a frequency domain to a time domain; and
a demultiplexer (DEMUX) configured to demultiplex the converted signals and to recover the demultiplexed signals so that the demultiplexed signals become raw digital signals.

14. The OFDM-based network apparatus of claim 13, wherein the decompressors are configured to decompress the compressed signals by using L1 minimalization.

15. The OFDM-based network apparatus of claim 10, wherein the demodulator is configured to receive the modulated compressed signal through a digital interface and demodulate the received modulated compressed signal.

16. The OFDM-based network apparatus of claim 10, wherein the demodulator comprises:
an equalizer (EQ) configured to perform equalization that is required for digital signal decompression by the recoverers.

17. A data compression and recovery method of an OFDM-based network apparatus, the data compression and recovery method comprising:
compressing raw digital signals by using compressed sensing (CS);
modulating and transmitting the compressed raw digital signals;
receiving and demodulating the modulated raw digital signals; and
recovering the raw digital signals by decompressing, by using CS, the demodulated raw digital signals.

18. The data compression and recovery method of claim 17, wherein the compressing of the raw digital signals comprises compressing the sampled raw digital signals by sampling the raw digital signals at a rate below a Nyquist rate, and
the recovering of a raw digital signal comprises, by using CS, recovering the raw digital signals based on the raw digital signals that have been sampled at a rate below the Nyquist rate and compressed.

19. The data compression and recovery method of claim 17, wherein the recovering of the raw digital signals comprises decompressing, by using L1 minimalization, the compressed raw digital signals.
